(19) United States
(12) Patent Application Publication
(10) Pub. No.: US 2009/0206712 A1
(43) Pub. Date: Aug. 20, 2009

(54) Vanity top assembly and packaging

(76) Inventor: Morris Bendah, San Ramon, CA (US)

Correspondence Address: MORRIS BENDAH, 2750 MERCED ST., SAN LEANDRO, CA, 94577, US

(21) Appl. No.: 12/322,209

(22) Filed: Jan. 29, 2009

Related U.S. Application Data
(60) Provisional application No. 61/024,502, filed on Jan. 29, 2008.

(51) Int. Cl. A47B 96/18; F16F 7/00

(52) U.S. Cl. 312/140.4; 267/141; 267/136

(57) ABSTRACT

There are a series of different length sized stone or engineered stone vanity tops that when used in conjunction with a standard sized “divider”, that incorporates a tissue box holder and/or a granite cup holder, longer vanity cabinets can be covered and smaller crates and boxes can be used for shipping. The present invention also provides that the packaging in the boxes is of a unique design in that no matter how the box is placed flat on the floor, the vanity top or divider slab will never be horizontal (which is its weakest position), but always be on an angle or vertical (which is its strongest position). The present invention also provides for integral reinforcement and clip within the vanity top itself that strengthens the area around the sink hole and allows the undermount sink to be fastened to the vanity top easily and in a non-permanent fashion. Protection and strengthening the edge of the vanity top is accomplished with aluminum extrusion around its perimeter which is covered with tight cardboard to increase tensional strength.

### FIELD OF THE INVENTION

The present invention relates to a Vanity Top System and, more particularly, to covering vanity cabinets with Stone, Engineered Stone or Solid Surface countertop including reinforcement, packaging and modular system for longer vanity tops and accessories.

### BACKGROUND OF THE INVENTION

Prefabricated Stone or Engineered Stone Vanity Tops have been in existence for many years and offer a cost effective alternative to custom-made stone or engineered stone vanity tops. Typically the prefabricated vanity tops are made in a factory where many similar tops are manufactured using mass production on automated machines, saving material costs and labor. Since vanity cabinets, especially in the smaller sizes of 48 inches or less, are standardized, and can be covered using prefabricated vanity tops, custom made vanity tops are not even necessary much of the time. In practice some vanity cabinets are larger than 48″ and up to 108″ or more in length. Typically, these larger vanity tops have more than one sink hole associated with them as well. The location of the sink-holes in the larger vanity tops cannot be standardized so usually a “custom” vanity top is required, costing much more money. When prefabricated Vanity Tops are sold in the Do-It-Yourself market, they must be transported to the customer in a way that the customer receives them in good condition and undamaged. Stone or Engineered Stone is very fragile, especially with polished undermount sink-holes already cut out for the customer. The weight of the stone itself, helps in breaking the vanity top around the sink-hole, since there is more weight on either side of the fragile sink-hole. The larger the vanity top, the worse this situation becomes. Once receiving the vanity top, the customer has to attach a sink to it, core out faucet holes if necessary, and install it on a Vanity Cabinet. Typical vanity tops have clips underneath for attaching the sink or a permanent epoxy glue is provided.

Smaller Prefabricated vanity tops are now usually distributed by large retailers where the customer picks up the item and takes it home. Not all customers are near these retailers and rural customers cannot be served. Also the stone vanity tops are very heavy and difficult to put in and take out of a vehicle. Larger vanity tops are not available prefabricated and are usually just custom-made for customers at a much higher cost, usually two to three times higher. Smaller vanity tops are shipped by commercial common carrier freight on pallets if shipped directly to customers, which is very expensive because there are high minimum charges and the pallet weighs as much or more than the vanity top. Lower priced normal packaging and parcel shipping usually results in damage because the handling is not consistent and easily dropped. These items are usually damaged by their own weight. Larger vanity tops of 48″ or larger are usually crated and sent by commercial common carrier or hand delivered using local trucks. Either way this is expensive because the crate easily weighs more than the vanity top. Also, very long vanity tops of more than 84″ are very difficult to ship this way because of the normal back door width of a common carrier truck is exceeded by the width of the crate.

Not all consumers are near large retailers where they could pick up the vanity top and take it home. Even stocking these stone vanity tops is problematic. They are often handled incorrectly in the retail aisle by customers and easily damaged. Since they can weigh 40-80 lbs, they are not moved easily, even for checking colors. The resulting breakage necessitates higher systemic pricing for all vanity tops sold. The carton packaging of vanity tops usually keeps them in a lateral position where they are the most vulnerable to breakage. Some vanities come with the sink already permanently attached to the vanity top in order to increase the strength of the vanity top. Some vanity tops come with epoxy to attach the sink yourself. Both these attachments are improper since it is a permanent attachment. If the sink is damaged, it cannot then be replaced, rendering the vanity top useless. Proper attachment is by using silicone sealant and mechanical clips. Prefabricated Vanity tops usually have faucet holes predrilled for 4 inch centers or 8 inch centers faucets, not both. A customer cannot change the faucet spacing that is existing on the vanity top. Larger vanity tops become expensive or impractical unless locally custom fabricated and delivered, which is expensive.

It is therefore an object of the invention to provide a modular system whereby long vanity cabinets can be covered using prefabricated vanity top material in stone or engineered stone (or composite plastics) by the use of a divider.

It is a further object of the invention to provide a divider that has an integral tissue holder.

It is a further object of the invention to provide a divider that has an integral cup holder and cups.

It is a further object of the invention to provide a divider that is thicker than the vanity tops so that it looks like it is joined and not a seamed together

It is another object of the invention to provide for integral reinforcement and clip within the vanity top itself that strengthens the area around the sink hole and allows the undermount sink to be fastened to the vanity top easily and in a non-permanent fashion.

It is a further object of the invention to provide faucet holes in the vanity top that are partially drilled on the back and filled with a filler such as polyester resin so that faucet hole pattern that the customer selects can be finished on site or before shipping.

It is another object of the invention to provide a package size that can ship stone or engineered stone vanity countertops without damage using ground parcel shipping services.

It is a further object of the invention to provide a package that keeps the vanity top or other slab of stone or engineered stone on its edge, and not flat or horizontal, when any flat side of the package is on the ground.

It is a further object of the invention to provide protection to the edges of the stone vanity top or slab in the package.

It is a further object of the invention to provide cardboard stretched tight around the vanity top and backsplash to increase their resistance to breakage.

### SUMMARY OF THE INVENTION

In accordance with the present invention, there is provided a series of different length sized stone or engineered stone vanity tops that when used in conjunction with a standard sized “divider”, that incorporates a tissue box holder and/or a granite cup holder, longer vanity cabinets can be covered and smaller crates and boxes can be used for shipping. The present invention also provides that the packaging in the boxes is of a unique design in that no matter how the box is placed flat on the floor, the vanity top or divider slab will never be horizontal (which is its weakest position), but always be on an angle or vertical (which is its strongest position). The present invention also provides for integral reinforcement and clip within the vanity top itself that strengthens the area around the sink hole and allows the undermount sink to be fastened to the vanity top easily and in a non-permanent fashion. Also, the vanity top is strengthened for shipping by attaching an aluminum “C” extrusion around its perimeter. Snug cardboard covering of the vanity top and backsplash increase the cross-sectional shear (or tension) of the pieces. Finally, the vanity tops have the feature of having the option of a single faucet hole which is already drilled, or 4″ centers or 8″ centers which are ⅔ drilled and then filled with polyester resin so that they can be drilled on site easily or drilled before shipping.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a prefabricated vanity top, a divider with tissue box and cup holders, a divider with only cup holders, and showing vanity tops with a divider between them.;

FIG. 2 is a perspective bottom view of a prefabricated vanity top showing predrilled and filled faucet holes and integral allthread sink hole support with clips for attaching sinks. Also sections are shown of the predrilled and filled faucet hole and the end of the allthread.; and

FIG. 3 is a perspective view of a box to contain a vanity top and backsplash with packing in exploded view and a side view of the box when laid flat. Also a top and section view of the vanity top showing aluminum extrusion reinforcement.

For purposes of clarity and brevity, like elements and components will bear the same designations and numbering throughout the FIGURES.

### DESCRIPTION OF THE PREFERRED EMBODIMENT

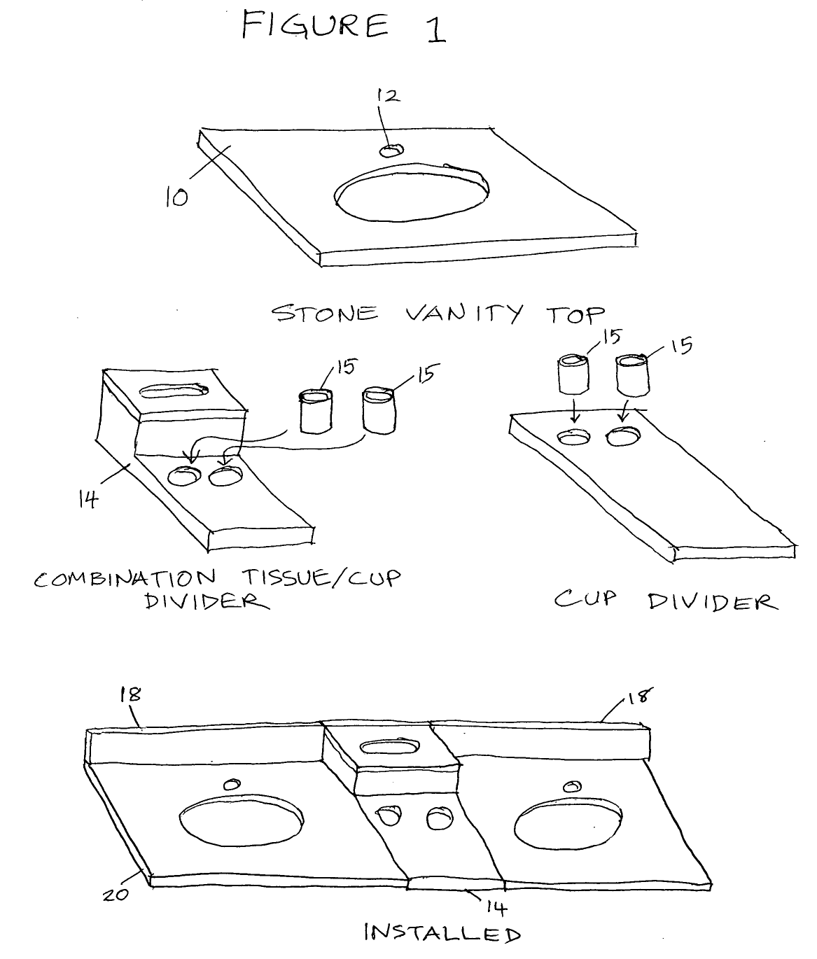

FIG. 1 is a perspective view of a Prefabricated Vanity Top 10 with a Single completely drilled faucet hole 12 and a prefinished and polished undermount sink hole. These vanity tops are typically 22″ deep to cover a 21 inch deep cabinet with one inch of reveal at the front. The width of these tops are 25.5″ to cover 24″ wide cabinet, 31.5″ to cover 30″ wide cabinet, 37.5″ to cover 36″ wide cabinet, 49.5″ to cover 48″ wide cabinet. Larger cabinets with two sink holes (which are usually symmetrical) can use two Vanity Top 10 and a Divider with tissue holder and Cup 15 15lder, or a Divider with just Cup 15 15lder. For example, a vanity cabinet that is 21″ deep by 60″ long would use two Vanity Top 10 that are 22″ by 25.5″ wide (trimmed to a smaller width to fit) and one Divider with tissue holder and Cup 15 15lder that is 14″ by 22″ deep to make a Large assembled vanity top 20 about 22″ deep by 62″ wide. Either divider could be used but the Divider with tissue holder and Cup 15 15lder does not require a small piece of Backsplash 18 behind it so it is preferred. The Dividers are 0.25″ thicker than the vanity top 10 so that the joints between them don't have to be exactly level, and so it appears as a joint, not a seam.

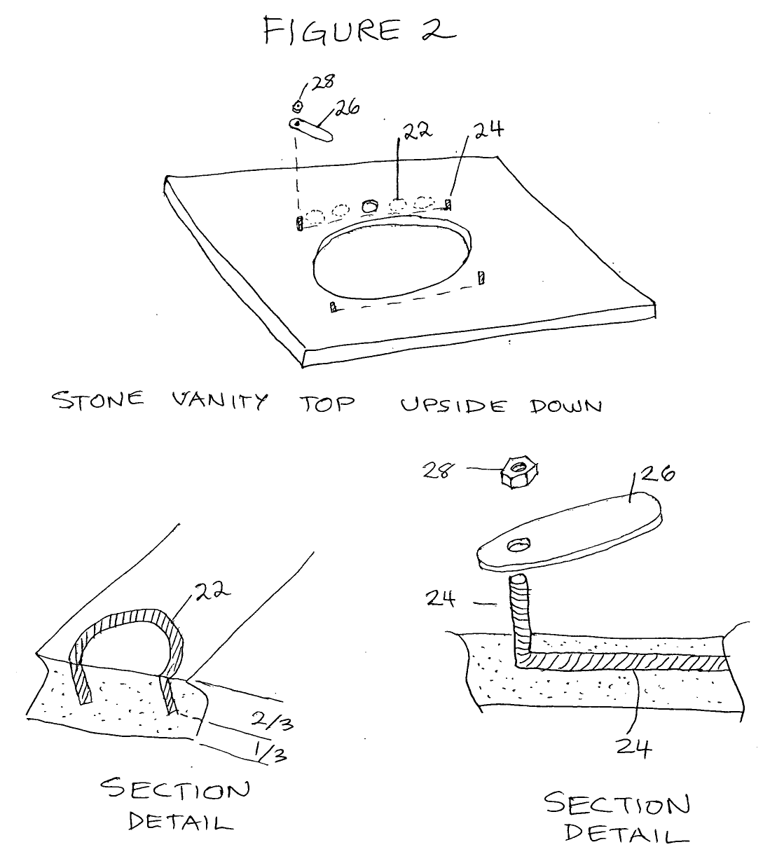

FIG. 2 which is a perspective bottom view of the prefabricated Vanity Top 10 showing Partially drilled faucet holes 22 and integral Allthread reinforcement 24 sink hole support with Clip 26 for attaching sinks. Also sections are shown of the Partially drilled faucet holes 22 and the end of the Allthread reinforcement 24. The Allthread reinforcement 24 typically 0.25″ in diameter is bent at ninety degrees at the ends so that when it is inserted in a groove that has been partially sawed on the back of the stone Vanity Top 10, threaded bolts are exposed for the Clip 26 and Nut 28. A polyester resin is used to anchor the Allthread reinforcement 24 in the stone groove. The Clip 26 has a rounded end so that it can extend over the rim of a sink and have maximum coverage. Typically a bead of silicone sealant caulking would be used between the Vanity Top 10 and the sink rim.

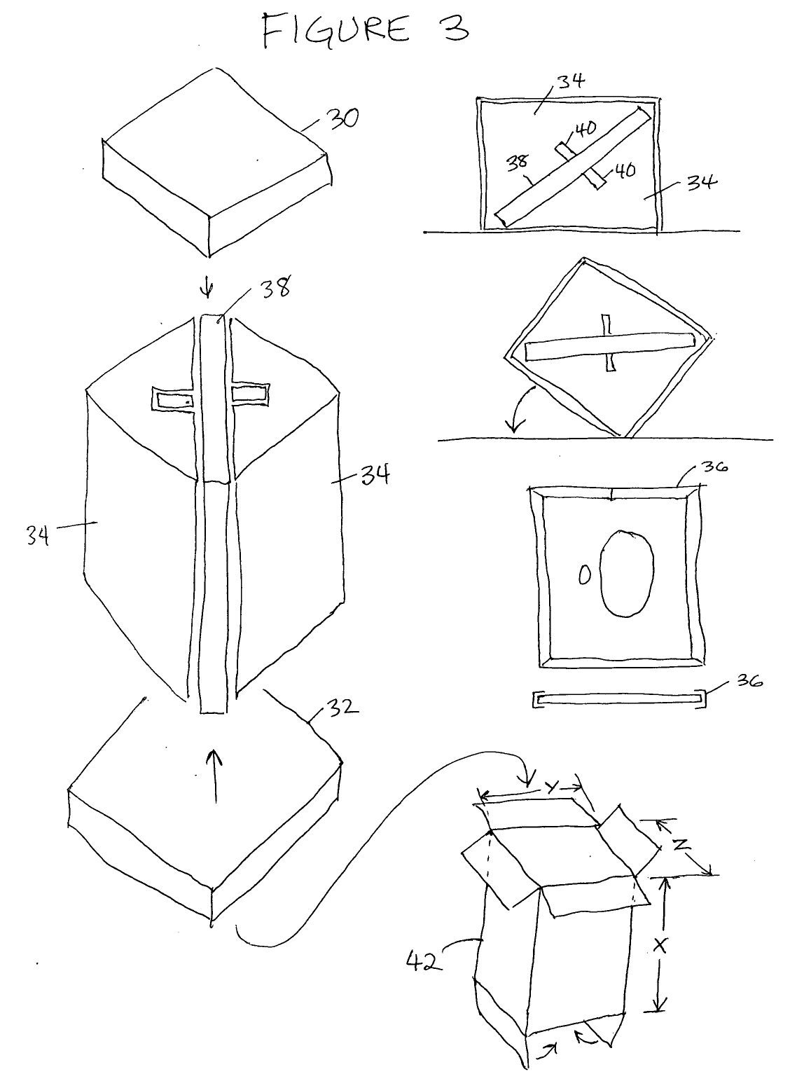

FIG. 3 which is a perspective view of the Outer cardboard box 42 to contain a Cardboard encased vanity top 38 and Cardboard encased backsplash 40 with packing in exploded view to show Upper rectangular foam block 30 and Lower rectangular foam block 32 and two Triangular foam blocks 34 which sandwich the Cardboard encased vanity top 38 and Cardboard encased backsplash 40. A side view of the box when laid flat shows the unique property of this package which is that it prevents the Vanity Top 10 or Backsplash 18 from being horizontal when the box is placed on the floor. Since the stone slabs have the least downward strength when horizontal, this helps avoid breakage immensely. Also a top and section view of the Vanity Top 10 showing Aluminum “C” extrusion 36 reinforcement around the perimeter of the vanity top 10. This extrusion, which which is bent over in the corners, protects the edge from chipping and distributes any shock over a larger area. The size of the outer cardboard box is such that the girth (two times Y plus two times Z) plus length (X) do not exceed the limits by parcel ground carriers for a vanity top 10 up to 22″ by 37.5″. As these limits may change from time to time so can the dimensions of the box. Y and Z do not need to be equal to accommodate changes.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A vanity top assembly and packaging for covering vanity cabinets with stone, engineered stone or solid surface countertop including reinforcement, packaging and modular system for longer vanity tops and accessories. comprising:
means for covering a vanity cabinet either by itself or with a divider and providing for various faucet hole configurations, reinforcement for sink hole and attachment of sink;
means for using in conjunction with vanity tops and assebled to cover a large vanity cabinet without the need for matching backsplash and to hold rinsing cups which could be made of matching stone and to hold a tissue box which can dispense tissue through the slit in the stone cover;
means for using in conjunction with vanity tops and assembled to cover a large vanity cabinet with the need for matching backsplash and to hold rinsing cups which could be made of matching stone;
means for having ready to drill faucet holes in standard configurations with the difficult stone drilling mostly done;
means for reinforcing the stone aroud the fragile sink hole and to attach sink to vanity top;
means for fitting inside the divider circular polished depressions which adds a high quality functional accessory to the divider;
means for absorbing the shock of the force of the box being dropped so that the stone is undamaged;
means for absorbing the shock of the force of the box being dropped so that the stone is undamaged;
means for insulating the vanity top from shock and keeping the vanity top and backsplashes from being parallel to the surface that the box is placed on, thereby ensuring that the vanity top and the backsplash are in a diagonal or vertical position compared to the ground, which is their strongest position;
means for reinforcing the edge of the vanity top before it is enveloped in cardboard so that any shock can be distributed evenly avoiding chips and breakage;
means for giving the vanity top more shear strength by wrapping it tightly with cardboard after the aluminum extrusion is applied; and
means for giving the backsplash and sidesplash more shear strength by wrapping them tightly with cardboard.

2. The vanity top assembly and packaging in accordance with claim 1, wherein said means for covering a vanity cabinet either by itself or with a divider and providing for various faucet hole configurations, reinforcement for sink hole and attachment of sink comprises a Partially drilled and filled faucet holes, Allthread reinforced sink hole with integral protruding bolts for clips, Clips and nuts attached to ends of allthread vanity top.

3. The vanity top assembly and packaging in accordance with claim 1, wherein said means for using in conjunction with vanity tops and assebled to cover a large vanity cabinet without the need for matching backsplash and to hold rinsing cups which could be made of matching stone and to hold a tissue box which can dispense tissue through the slit in the stone cover
comprises a Thicker than vanity top at front, Made of matching stone, Tissue box is same height as the vanity backsplash, shallow circular polished depressions where cups will be set, Rectangular stone lid for tissue holder with slit for dispensing tissues divider with tissue holder and cup holder.

4. The vanity top assembly and packaging in accordance with claim 1, wherein said means for using in conjunction with vanity tops and assembled to cover a large vanity cabinet with the need for matching backsplash and to hold rinsing cups which could be made of matching stone comprises a thicker than vanity top, made of matching stone, shallow circular polished depressions where cups will be set divider with just cup holder.

5. The vanity top assembly and packaging in accordance with claim 1, wherein said means for having ready to drill faucet holes in standard configurations with the difficult stone drilling mostly done comprises a filled with polyester resin, four inches apart and eight inches apart center on center partially drilled faucet holes.

6. The vanity top assembly and packaging in accordance with claim 1, wherein said means for reinforcing the stone aroud the fragile sink hole and to attach sink to vanity top comprises a fits in channel cut into stone at front and back of sink hole, covered with polyester resin to anchor in place, has 90 degree bends on ends so that it is an integral bold for clips, clips and nuts fit on protruding ends to attach sink allthread reinforcement.

7. The vanity top assembly and packaging in accordance with claim 1, wherein said means for fitting inside the divider circular polished depressions which adds a high quality functional accessory to the divider comprises a can be made from matching stone cup.

8. The vanity top assembly and packaging in accordance with claim 1, wherein said means for absorbing the shock of the force of the box being dropped so that the stone is undamaged comprises an at the top of box, a thickness of at least 3 inches upper rectangular foam block.

9. The vanity top assembly and packaging in accordance with claim 1, wherein said means for absorbing the shock of the force of the box being dropped so that the stone is undamaged comprises an at the bottom of box, a thickness of at least 3 inches lower rectangular foam block.

10. The vanity top assembly and packaging in accordance with claim 1, wherein said means for insulating the vanity top from shock and keeping the vanity top and backsplashes from being parallel to the surface that the box is placed on, thereby ensuring that the vanity top and the backsplash are in a diagonal or vertical position compared to the ground, which is their strongest position comprises a has notch through its length for holding backsplash and sidesplash, same lenght as the cardboard enclosed vanity top triangular foam blocks.

11. The vanity top assembly and packaging in accordance with claim 1, wherein said means for reinforcing the edge of the vanity top before it is enveloped in cardboard so that any shock can be distributed evenly avoiding chips and breakage comprises a fits snuggly around edge of vanity top, joints cannot be in corners aluminum “c” extrusion.

12. The vanity top assembly and packaging in accordance with claim 1, wherein said means for giving the vanity top more shear strength by wrapping it tightly with cardboard after the aluminum extrusion is applied comprises a Cardboard must be tight to give shear strength cardboard encased vanity top.

13. The vanity top assembly and packaging in accordance with claim 1, wherein said means for giving the backsplash and sidesplash more shear strength by wrapping them tightly with cardboard comprises a Cardboard must be tight to give shear cardboard encased backsplash.

14. A vanity top assembly and packaging for covering vanity cabinets with stone, engineered stone or solid surface countertop including reinforcement, packaging and modular system for longer vanity tops and accessories. comprising:
a Partially drilled and filled faucet holes, Allthread reinforced sink hole with integral protruding bolts for clips, Clips and nuts attached to ends of allthread vanity top, for covering a vanity cabinet either by itself or with a divider and providing for various faucet hole configurations, reinforcement for sink hole and attachment of sink;
a Thicker than vanity top at front, Made of matching stone, Tissue box is same height as the vanity backsplash, shallow circular polished depressions where cups will be set, Rectangular stone lid for tissue holder with slit for dispensing tissues divider with tissue holder and cup holder, for using in conjunction with vanity tops and assebled to cover a large vanity cabinet without the need for matching backsplash and to hold rinsing cups which could be made of matching stone and to hold a tissue box which can dispense tissue through the slit in the stone cover;
a thicker than vanity top, made of matching stone, shallow circular polished depressions where cups will be set divider with just cup holder, for using in conjunction with vanity tops and assembled to cover a large vanity cabinet with the need for matching backsplash and to hold rinsing cups which could be made of matching stone;
a filled with polyester resin, four inches apart and eight inches apart center on center partially drilled faucet holes, for having ready to drill faucet holes in standard configurations with the difficult stone drilling mostly done;
a fits in channel cut into stone at front and back of sink hole, covered with polyester resin to anchor in place, has 90 degree bends on ends so that it is an integral bold for clips, clips and nuts fit on protruding ends to attach sink allthread reinforcement, for reinforcing the stone aroud the fragile sink hole and to attach sink to vanity top;
a can be made from matching stone cup, for fitting inside the divider circular polished depressions which adds a high quality functional accessory to the divider;
an at the top of box, a thickness of at least 3 inches upper rectangular foam block, for absorbing the shock of the force of the box being dropped so that the stone is undamaged;
an at the bottom of box, a thickness of at least 3 inches lower rectangular foam block, for absorbing the shock of the force of the box being dropped so that the stone is undamaged;
a has notch through its length for holding backsplash and sidesplash, same lenght as the cardboard enclosed vanity top triangular foam blocks, for insulating the vanity top from shock and keeping the vanity top and backsplashes from being parallel to the surface that the box is placed on, thereby ensuring that the vanity top and the backsplash are in a diagonal or vertical position compared to the ground, which is their strongest position;
a fits snuggly around edge of vanity top, joints cannot be in corners aluminum “c” extrusion, for reinforcing the edge of the vanity top before it is enveloped in cardboard so that any shock can be distributed evenly avoiding chips and breakage;
a Cardboard must be tight to give shear strength cardboard encased vanity top, for giving the vanity top more shear strength by wrapping it tightly with cardboard after the aluminum extrusion is applied; and
a Cardboard must be tight to give shear cardboard encased backsplash, for giving the backsplash and sidesplash more shear strength by wrapping them tightly with cardboard.

15. A vanity top assembly and packaging for covering vanity cabinets with stone, engineered stone or solid surface countertop including reinforcement, packaging and modular system for longer vanity tops and accessories. comprising:
a Partially drilled and filled faucet holes, Allthread reinforced sink hole with integral protruding bolts for clips, Clips and nuts attached to ends of allthread vanity top, for covering a vanity cabinet either by itself or with a divider and providing for various faucet hole configurations, reinforcement for sink hole and attachment of sink;
a Thicker than vanity top at front, Made of matching stone, Tissue box is same height as the vanity backsplash, shallow circular polished depressions where cups will be set, Rectangular stone lid for tissue holder with slit for dispensing tissues divider with tissue holder and cup holder, for using in conjunction with vanity tops and assebled to cover a large vanity cabinet without the need for matching backsplash and to hold rinsing cups which could be made of matching stone and to hold a tissue box which can dispense tissue through the slit in the stone cover;
a thicker than vanity top, made of matching stone, shallow circular polished depressions where cups will be set divider with just cup holder, for using in conjunction with vanity tops and assembled to cover a large vanity cabinet with the need for matching backsplash and to hold rinsing cups which could be made of matching stone;
a filled with polyester resin, four inches apart and eight inches apart center on center partially drilled faucet holes, for having ready to drill faucet holes in standard configurations with the difficult stone drilling mostly done;
a fits in channel cut into stone at front and back of sink hole, covered with polyester resin to anchor in place, has 90 degree bends on ends so that it is an integral bold for clips, clips and nuts fit on protruding ends to attach sink allthread reinforcement, for reinforcing the stone aroud the fragile sink hole and to attach sink to vanity top;
a can be made from matching stone cup, for fitting inside the divider circular polished depressions which adds a high quality functional accessory to the divider;
an at the top of box, a thickness of at least 3 inches upper rectangular foam block, for absorbing the shock of the force of the box being dropped so that the stone is undamaged;
an at the bottom of box, a thickness of at least 3 inches lower rectangular foam block, for absorbing the shock of the force of the box being dropped so that the stone is undamaged;
a has notch through its length for holding backsplash and sidesplash, same lenght as the cardboard enclosed vanity top triangular foam blocks, for insulating the vanity top from shock and keeping the vanity top and backsplashes from being parallel to the surface that the box is placed on, thereby ensuring that the vanity top and the backsplash are in a diagonal or vertical position compared to the ground, which is their strongest position;
a fits snuggly around edge of vanity top, joints cannot be in corners aluminum “c” extrusion, for reinforcing the edge of the vanity top before it is enveloped in cardboard so that any shock can be distributed evenly avoiding chips and breakage;
a Cardboard must be tight to give shear strength cardboard encased vanity top, for giving the vanity top more shear strength by wrapping it tightly with cardboard after the aluminum extrusion is applied; and
a Cardboard must be tight to give shear cardboard encased backsplash, for giving the backsplash and sidesplash more shear strength by wrapping them tightly with cardboard.
